(19) United States
(12) Patent Application Publication
(10) Pub. No.: US 2024/0012668 A1
(43) Pub. Date: Jan. 11, 2024

(54) INTEGRATED HARDWARE COMPATABILITY AND HEALTH CHECKS FOR A VIRTUAL STORAGE AREA NETWORK (VSAN) DURING VSAN CLUSTER BOOTSTRAPPING

(71) Applicant: VMWare, Inc., Palo Alto, CA (US)

(72) Inventors: Anmol Parikh, Varanasi (IN); Akash Kodenkiri, Bangalore (IN); Sandeep Sinha, Bangalore (IN); Ammar Rizvi, Bangalore (IN); Niharika Narasimhamurthy, Bangalore (IN)

(21) Appl. No.: 17/896,192

(22) Filed: Aug. 26, 2022

(30) Foreign Application Priority Data
Jul. 7, 2022 (IN) 202241039109

(51) Int. Cl. G06F 9/455; G06F 3/06

(52) U.S. Cl. CPC G06F 9/45558; G06F 3/0604; G06F 3/0631; G06F 3/0664; G06F 3/067; G06F 2009/45583

(57) ABSTRACT

A method performing at least one of hardware component compatibility checks or resource checks for datastore deployment is provided. The method includes receiving a request to aggregate local disks of a first host in a first host cluster to create and deploy a first datastore for the first host cluster, determining one or more of hardware components on the first host supports the deployment of the first datastore using a first database file available on the first host or resources on the first host support the deployment of the first datastore, and aggregating the local disks of the first host to create and deploy the first datastore for the first host cluster based on the determination.

### RELATED APPLICATIONS

Benefit is claimed under 35 U.S.C. 119(a)-(d) to Foreign Application Serial No. 202241039109 filed in India entitled “INTEGRATED HARDWARE COMPATABILITY AND HEALTH CHECKS FOR A VIRTUAL STORAGE AREA NETWORK (VSAN) DURING VSAN CLUSTER BOOTSTRAPPING”, on Jul. 7, 2022, by VMware, Inc., which is herein incorporated in its entirety by reference for all purposes.

### BACKGROUND

A software-defined data center (SDDC) may comprise a plurality of hosts in communication over a physical network infrastructure. Each host is a physical computer (machine) that may run one or more virtualized endpoints such as virtual machines (VMs), containers, and/or other virtual computing instances (VCIs). In some cases, VCIs are connected to software-defined networks (SDNs), also referred to herein as logical overlay networks, that may span multiple hosts and are decoupled from the underlying physical network infrastructure. Various services may run on hosts in SDDCs, and may be implemented in a fault tolerant manner, such as through replication across multiple hosts.

In some cases, multiple hosts may be grouped into clusters. A cluster is a set of hosts configured to share resources, such as processor, memory, network, and/or storage. In particular, when a host is added to a cluster, the host's resources may become part of the cluster's resources. A cluster manager manages the resources of all hosts within the cluster. Clusters may provide high availability (e.g., a system characteristic that describes its ability to operate continuously without downtime) and load balancing solutions in the SDDC.

In some cases, a cluster of host computers may aggregate local disks (e.g., solid state drive (SSD), peripheral component interconnect (PCI)-based flash storage, etc.) located in, or attached to, each host computer to create a single and shared pool of storage. In particular, a storage area network (SAN) is a dedicated, independent high-speed network that may interconnect and delivers shared pools of storage devices to multiple hosts. A virtual SAN (VSAN) may aggregate local or direct-attached data storage devices, to create a single storage pool shared across all hosts in a host cluster. This pool of storage (sometimes referred to herein as a “datastore” or “data storage”) may allow VMs running on hosts in the host cluster to store virtual disks that are accessed by the VMs during their operations. In some cases, the VSAN architecture may be a two-tier datastore including a performance tier for the purpose of read caching and write buffering and a capacity tier for persistent storage.

VSAN cluster bootstrapping is the process of (1) joining multiple hosts together to create the cluster and (2) aggregating local disks located in, or attached to, each host to create and deploy the VSAN such that it is accessible by all hosts in the host cluster. In some cases, prior to such bootstrapping, the hardware on each host to be included in the cluster may be checked to help ensure smooth VSAN deployment, as well as to avoid degradation of performance when using the VSAN subsequent to deployment. Further, using incompatible hardware with VSAN may put users' data at risk. In particular, incompatible hardware may be unable to support particular software implemented for VSAN; thus, security patches and/or other steps software manufacturers take to address vulnerabilities with VSAN may not be supported. Accordingly, data stored in VSAN may become more and more vulnerable, resulting in an increased risk of being breached by malware and ransomware.

A hardware compatibility check is an assessment used to check whether user inventory on each host, which will share a VSAN datastore, is compatible for VSAN enablement. For example, where a cluster is to include three hosts, hardware components on each of the three hosts may be assessed against a database file. The database file may be a file used to validate whether hardware on each host is compatible for VSAN deployment. The database file may contain certified hardware components such as, peripheral component interconnect (PCI) devices, central processing unit (CPU) models, etc. for which hardware components on each host may be compared against. A hardware component may be deemed compatible where a model, vendor, driver, and/or firmware version of the hardware component is found in the database file (e.g., indicating the hardware component is supported).

In some cases, a user manually performs the hardware compatibility check. For example, a user may manually check the compliance of each and every component on each host (e.g., to be included in a host cluster and share a VSAN datastore) against the database file. The user may decide whether to create the VSAN bootstrapped cluster based on performing this comparison. Unfortunately, manually checking the compatibility of each component on each host may become cumbersome where there are a large number of components, and/or a large number of hosts which need to be checked. Further, manually checking each component may be vulnerable to some form of human error. Even a seemingly minor mistake may lead to issues during installation and deployment of the VSAN.

Accordingly, in some other cases, an automated tool is used remedy the ills of such manual processing. In particular, an automated hardware compatibility checker may be used to assess the compatibility of hardware components on each host for VSAN enablement. The automated hardware compatibility checker may generate an assessment report and provide the report to a user prior to the user setting up the VSAN cluster. However, the automated checker may require a user to download and run the tool prior to running an installer (e.g., a command line input (CLI) installer) to set up the cluster, deploy VSAN, and install a virtualization manager that executes in a central server in the SDDC. The virtualization manager may be installed to carry out administrative tasks for the SDDC, including managing hosts, managing hosts running within each host cluster, managing VMs running within each host, provisioning VMs, transferring VMs 105 between hosts and/or host clusters, etc. Accordingly, the automated tool may not be integrated within the installer; thus, performing the hardware compatibility check may not be efficient and/or convenient for a user to run. Further, such a solution may not provide real-time hardware compliance information.

It should be noted that the information included in the Background section herein is simply meant to provide a reference for the discussion of certain embodiments in the Detailed Description. None of the information included in this Background should be considered as an admission of prior art.

### SUMMARY

A method of performing at least one of hardware component compatibility checks or resource checks for datastore deployment is provided. The method includes: receiving a request to aggregate local disks of a first host in a first host cluster to create and deploy a first datastore for the first host cluster, determining one or more of hardware components on the first host supports the deployment of the first datastore using a first database file available on the first host or resources on the first host support the deployment of the first datastore, and aggregating the local disks of the first host to create and deploy the first datastore for the first host cluster based on the determination.

Further embodiments include a non-transitory computer-readable storage medium storing instructions that, when executed by a computer system, cause the computer system to perform the method set forth above. Further embodiments include a computing system comprising at least one memory and at least one processor configured to perform the method set forth above.

### BRIEF DESCRIPTION OF THE DRAWINGS

FIG. 1 is a diagram depicting example physical and virtual components in a data center with which embodiments of the present disclosure may be implemented.

FIG. 2 illustrates an example workflow for performing hardware compatibility and health checks prior to virtual storage area network (VSAN) creation and deployment, according to an example embodiment of the present disclosure.

FIG. 3 is a call flow diagram illustrating example operations for virtualization manager installation, according to an example embodiment of the present disclosure.

FIG. 4 is an example state diagram illustrating different states during a VSAN bootstrap workflow, according to embodiments of the present disclosure.

FIG. 5 is a flow diagram illustrating example operations for performing at least one of hardware component compatibility checks or resource checks for datastore deployment, according to an example embodiment of the present disclosure.

### DETAILED DESCRIPTION

Aspects of the present disclosure introduce a workflow for automatically performing hardware compatibility and/or health checks for virtual storage area network (VSAN) enablement during a VSAN cluster bootstrap. As used herein, automatic performance may refer to performance with little, or no, direct human control or intervention. The workflow may be integrated with current installation workflows (e.g., with a current installer) performed to set up a cluster, deploy VSAN within the cluster, and install a virtualization manager that provides a single point of control to hosts within the cluster. As such, a single process may be used for (1) validating hardware compliance and/or health on a host to be included in a cluster, against a desired VSAN version and (2) creating a VSAN bootstrapped cluster using the desired VSAN version. As mentioned, a hardware compatibility check may be an assessment used to ensure that each hardware component running on the host (e.g., to be included in the cluster) comprises a model, version, and/or has firmware that is supported by a VSAN version to be deployed for the cluster. On the other hand, a health check may assess factors such as available memory, processors (central processing unit (CPU)), disk availability, network interface card (NIC) link speed, etc. to help avoid performance degradation of the system after VSAN deployment.

In certain aspects, VSAN comprises a feature, referred to herein as VSAN Max, which enables an enhanced data path for VSAN to support a next generation of devices. VSAN Max may be designed to support demanding workloads with high-performing storage devices to result in greater performance and efficiency of such devices. VSAN Max may be enabled during operations for creating a host cluster. Accordingly, the workflow for automatically performing hardware compatibility and/or health checks for VSAN enablement, described herein, may be for at least one of VSAN or VSAN Max.

Different techniques, including using a graphical user interface (GUI) or a command line interface (CLI), may be used to create a single host cluster, deploy VSAN within the host cluster, and install a virtualization manager that provides a single point of control to hosts within the cluster. Aspects herein may be described with respect to using a CLI installer, and more specifically, using a customized JavaScript Object Notation (JSON) file and creating the cluster, deploying VSAN, and launching the install of a virtual server appliance for running a virtualization manager from the command line. Further, hardware compatibility and/or health checks described herein may be integrated with the CLI installer. The CLI installer may support the creation of a single host VSAN cluster. Additional hosts may be added to the cluster after creation of the single host VSAN cluster (e.g., a message in a log may be presented to a user to add additional hosts to the cluster).

For example, a user may call the CLI installer to trigger VSAN deployment and virtualization manager appliance installation for a single host cluster. Before creating the VSAN bootstrapped cluster, the CLI installer may interact with an agent on a host, to be included in the cluster, to trigger hardware compatibility and/or health checks for hardware components on the corresponding host. In certain aspects, an agent checks the compliance of one or more components on the corresponding host (e.g., where the agent is situated) against a database file. A hardware component may be deemed compatible where a model, driver, and/or firmware version of the hardware component is found in the database file (e.g., indicating the hardware component is supported). In certain aspects, an agent checks the available memory, CPU, disks, NIC link speed, etc. on the host against what is required (e.g., pre-determined requirements) for VSAN deployment.

In some cases, the CLI installer may terminate VSAN deployment and virtual sever appliance installation (e.g., for running a virtualization manager) and provide an error message to a user where an agent on a host within the cluster determines that major compatibility issues exist for such VSAN deployment. In some other cases, the CLI installer may continue with VSAN deployment and virtual server appliance installation where hardware compatibility and/or health checks performed on the host within the cluster indicates minor, or no, issues with respect to VSAN deployment. Though certain aspects are described with respect to use of a CLI installer, the techniques described herein may similarly be used with any suitable installer component and/or feature.

As mentioned, to perform such hardware compatibility checks, a database file may be used. The database file may contain information about certified hardware components such as, peripheral component interconnect (PCI) devices, CPU models, etc. and their compatibility matrix for supported host version releases. The database file may need to be accessible by an agent on the host. Further, the database file may need to be up-to-date such that the database file contains the most relevant information about new and/or updated hardware. However, in certain aspects, the database file may not be present on the host or may be present on the host but comprise an outdated version of the file. Accordingly, aspects described herein provide techniques for providing up-to-date database files to hosts to allow for performance of the hardware compatibility checks described herein. Techniques for providing an up-to-date database file to both an internet-connected host and an air gapped host (e.g., a host without a physical connection to the public network or to any other local area network) are described herein.

Integrating hardware compatibility and/or health checks into the workflow for creating a VSAN bootstrapped cluster may provide real-time compliance information prior to enablement of VSAN for the cluster. Further, the hardware compatibility and/or health checks described herein may be automatically performed, thereby providing a more efficient and accurate process, as compared to manual processes for performing hardware compatibility and/or health checks when creating a VSAN bootstrapped cluster.

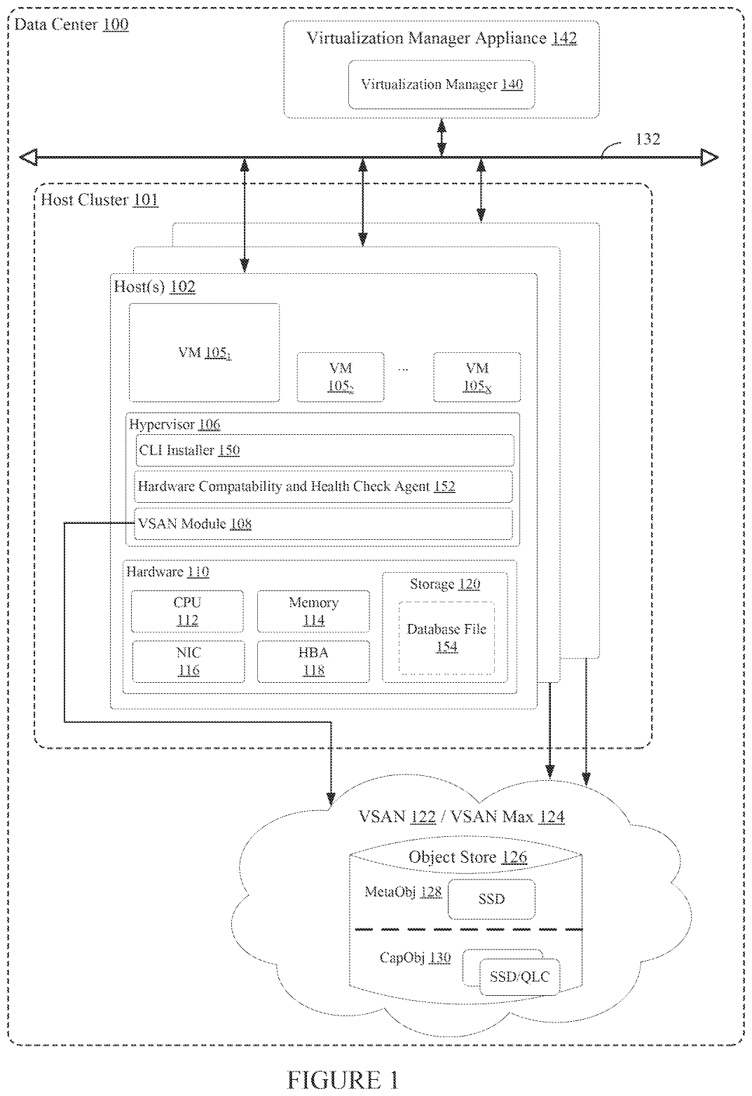

FIG. 1 is a diagram depicting example physical and virtual components, in a data center 100, with which embodiments of the present disclosure may be implemented. Data center 100 generally represents a set of networked computing entities, and may comprise a logical overlay network. As illustrated in FIG. 1, data center 100 includes host cluster 101 having one or more hosts 102, a management network 132, a virtualization manager 140, and a distributed object-based datastore, such as a software-based VSAN environment, VSAN 122. Management network 132 may be a physical network or a virtual local area networks (VLAN).

Each of hosts 102 may be constructed on a server grade hardware platform 110, such as an x86 architecture platform. For example, hosts 102 may be geographically co-located servers on the same rack or on different racks. A host 102 is configured to provide a virtualization layer, also referred to as a hypervisor 106, that abstracts processor, memory, storage, and networking resources of hardware platform 110 into multiple virtual machines (VMs) 1051 to 105x (collectively referred to as VMs 105 and individually referred to as VM 105) that run concurrently on the same host 102. As shown, multiples VMs 105 may run concurrently on the same host 102.

Each of hypervisors 106 may run in conjunction with an operating system (OS) (not shown) in its respective host 102. In some embodiments, hypervisor 106 can be installed as system level software directly on hardware platform 110 of host 102 (often referred to as “bare metal” installation) and be conceptually interposed between the physical hardware and the guest OSs executing in the VMs 105. In certain aspects, hypervisor 106 implements one or more logical entities, such as logical switches, routers, etc. as one or more virtual entities such as virtual switches, routers, etc. Although aspects of the disclosure are described with reference to VMs, the teachings herein also apply to other types of virtual computing instances (VCIs) or data compute nodes (DCNs), such as containers, which may be referred to as Docker containers, isolated user space instances, namespace containers, etc., or even to physical computing devices. In certain embodiments, VMs 105 may be replaced with containers that run on host 102 without the use of hypervisor 106.

In certain aspects, hypervisor 106 may include a CLI installer 150 (e.g., running on an operating system (OS) of a network client machine). In certain aspects, hypervisor 160 may include a hardware compatibility and health check agent 152 (referred to here as “Agent 152”). CLI installer and Agent 152 are described in more detail below. Though CLI installer 150 is illustrated in hypervisor 106 on host 102 in FIG. 1, in certain aspects, CLI installer 150 may be installed outside of host 102, for example, on virtualization manager 140 or another computing device. In certain other aspects, CLI installer 150 may run on a jumphost. A jumphost, also referred to as a jump server, may be an intermediary host or a gateway to remote network, through which a connection can be made to another host 102.

Hardware platform 110 of each host 102 includes components of a computing device such as one or more processors (CPUs) 112, memory 114, a network interface card including one or more network adapters, also referred to as NICs 116, storage system 120, a host bus adapter (HBA) 118, and other input/output (I/O) devices such as, for example, a mouse and keyboard (not shown). CPU 112 is configured to execute instructions, for example, executable instructions that perform one or more operations described herein and that may be stored in memory 114 and in storage system 120.

Memory 114 is hardware allowing information, such as executable instructions, configurations, and other data, to be stored and retrieved. Memory 114 is where programs and data are kept when CPU 112 is actively using them. Memory 114 may be volatile memory or non-volatile memory. Volatile or non-persistent memory is memory that needs constant power in order to prevent data from being erased. Volatile memory describes conventional memory, such as dynamic random access memory (DRAM). Non-volatile memory is memory that is persistent (non-volatile). Non-volatile memory is memory that retains its data after having power cycled (turned off and then back on). Non-volatile memory is byte-addressable, random access non-volatile memory.

NIC 116 enables host 102 to communicate with other devices via a communication medium, such as management network 132. HBA 118 couples host 102 to one or more external storages (not shown), such as a storage area network (SAN). Other external storages that may be used include network-attached storage (NAS) and other network data storage systems, which may be accessible via NIC 116.

Storage system 120 represents persistent storage devices (e.g., one or more hard disks, flash memory modules, solid state disks (SSDs), and/or optical disks). In certain aspects, storage system 120 comprises a database file 154. Database file 154 may contain certified hardware components and their compatibility matrix for VSAN 122 (and/or VSAN Max 124) deployment. Database file 154 may include a model, driver, and/or firmware version of a plurality of hardware components. As described in more detail below, in certain aspects, database file 154 may be used to check the compliance of hardware components on a host 102 for VSAN 122 (and/or VSAN Max 124) deployment for host cluster 101. Though database file 154 is stored in storage system 120 in FIG. 1, in certain aspects, database file 154 is stored in memory 114.

Virtualization manager 140 generally represents a component of a management plane comprising one or more computing devices responsible for receiving logical network configuration inputs, such as from a network administrator, defining one or more endpoints (e.g., VCIs and/or containers) and the connections between the endpoints, as well as rules governing communications between various endpoints. In certain aspects, virtualization manager 140 is associated with host cluster 101.

In certain aspects, virtualization manager 140 is a computer program that executes in a central server in data center 100. Alternatively, in another embodiment, virtualization manager 140 runs in a VCI. Virtualization manager 140 is configured to carry out administrative tasks for data center 100, including managing a host cluster 101, managing hosts 102 running within a host cluster 101, managing VMs 105 running within each host 102, provisioning VMs 105, transferring VMs 105 from one host 102 to another host 102, transferring VMs 105 between data centers 100, transferring application instances between VMs 105 or between hosts 102, and load balancing among hosts 102 within host clusters 101 and/or data center 100. Virtualization manager 140 takes commands from components located on management network 132 as to creation, migration, and deletion decisions of VMs 105 and application instances in data center 100. However, virtualization manager 140 also makes independent decisions on management of local VMs 105 and application instances, such as placement of VMs 105 and application instances between hosts 102. One example of a virtualization manager 140 is the vCenter Server™ product made available from VMware, Inc. of Palo Alto, California.

In certain aspects, a virtualization manager appliance 142 is deployed in data center 100 to run virtualization manger 140. Virtualization manager appliance 142 may be a preconfigured VM that is optimized for running virtualization manager 140 and its associated services. In certain aspects, virtualization manager appliance 142 is deployed on host 102. In certain aspects, virtualization manager appliance 142 is deployed on a virtualization manager 140 instance. One example of a virtualization manager appliance 142 is the vCenter Server Appliance (vCSA)™ product made available from VMware, Inc. of Palo Alto, California.

VSAN 122 is a distributed object-based datastore that leverages the commodity local storage housed in or directly attached (hereinafter, use of the term “housed” or “housed in” may be used to encompass both housed in or otherwise directly attached) to host(s) 102 of a host cluster 101 to provide an aggregate object storage to VMs 105 running on the host(s) 102. The local commodity storage housed in hosts 102 may include combinations of solid state drives (SSDs) or non-volatile memory express (NVMe) drives, magnetic or spinning disks or slower/cheaper SSDs, or other types of storages.

Additional details of VSAN are described in U.S. Pat. No. 10,509,708, the entire contents of which are incorporated by reference herein for all purposes, and U.S. patent application Ser. No. 17/181,476, the entire contents of which are incorporated by reference herein for all purposes.

As described herein, VSAN 122 is configured to store virtual disks of VMs 105 as data blocks in a number of physical blocks, each physical block having a PBA that indexes the physical block in storage. VSAN module 108 may create an “object” for a specified data block by backing it with physical storage resources of an object store 126 (e.g., based on a defined policy).

VSAN 122 may be a two-tier datastore, storing the data blocks in both a smaller, but faster, performance tier and a larger, but slower, capacity tier. The data in the performance tier may be stored in a first object (e.g., a data log that may also be referred to as a MetaObj 128) and when the size of data reaches a threshold, the data may be written to the capacity tier (e.g., in full stripes) in a second object (e.g., CapObj 130) in the capacity tier. SSDs may serve as a read cache and/or write buffer in the performance tier in front of slower/cheaper SSDs (or magnetic disks) in the capacity tier to enhance I/O performance. In some embodiments, both performance and capacity tiers may leverage the same type of storage (e.g., SSDs) for storing the data and performing the read/write operations. Additionally, SSDs may include different types of SSDs that may be used in different tiers in some embodiments. For example, the data in the performance tier may be written on a single-level cell (SLC) type of SSD, while the capacity tier may use a quad-level cell (QLC) type of SSD for storing the data.

Each host 102 may include a storage management module (referred to herein as a VSAN module 108) in order to automate storage management workflows (e.g., create objects in MetaObj 128 and CapObj 130 of VSAN 122, etc.) and provide access to objects (e.g., handle I/O operations to objects in MetaObj 128 and CapObj 130 of VSAN 122, etc.) based on predefined storage policies specified for objects in object store 126.

In certain aspects, VSAN 122 comprises a feature, referred to herein as VSAN Max 124. VSAN Max 124 may enable an enhanced data path for VSAN to support a next generation of devices. In certain aspects, VSAN 122 and/or VSAN Max 124 may be deployed for host cluster 101.

According to aspects described herein, CLI installer 150 may be configured to allow a user to (1) create and deploy VSAN 122 (and/or VSAN Max 124) for host cluster 101 (e.g., where host cluster 101 has one or more hosts 102) and (2) bootstrap host cluster 101, having VSAN 122 and/or VSAN Max 124, with virtualization manager 140 to create the computing environment illustrated in FIG. 1. In particular, to create and deploy VSAN 122 (and/or VSAN Max 124) for host cluster 101, CLI installer 150 may communicate with agent 152 on a host 102 to be included in host cluster 101 to first trigger hardware compatibility and/or health checks for hardware components on the corresponding host 102. In certain aspects, agent 152 checks the compliance of one or more components on the corresponding host (e.g., where agent 152 is situated) against database file 154. In certain aspects, agent 152 checks the available memory 114, CPU 112, disks, NIC 116 link speed, etc. on the corresponding host 102 against what is required for VSAN 122 (and/or VSAN Max 124) deployment. Agent 152 may generate a report indicating whether the hardware compatibility and/or health checks were successful (or passed with minor issues) and provide the report to a CLI installer 150 prior to setting up the VSAN 122 (and/or VSAN Max 124) cluster 101. Disks from host 102 in host cluster 101 may be used to create and deploy VSAN 122 (and/or VSAN Max 124) where the report indicates the checks were successful, or passed with minor issues. After creation, VSAN 122 (and/or VSAN Max) may be deployed for cluster 101 to form a VSAN bootstrapped cluster. In certain aspects, additional hosts 102 may be added to the single host VSAN cluster after creation of the cluster.

Subsequent to deploying the VSAN for cluster 101, virtualization manager appliance 142 may be installed and deployed. In certain aspects, a GUI installer may be used to perform an interactive deployment of virtualization manager appliance 142. For example, when using a GUI installer, deployment of the virtualization manager appliance 142 may include two stages. With stage 1 of the deployment process, an open virtual appliance (OVA) file is deployed as virtualization manager appliance 142. When the OVA deployment finishes, in stage 2 of the deployment process, services of virtualization manager appliance 142 are set up and started. In certain other aspects, CLI installer 150 may be used to perform an unattended/silent deployment of virtualization manager appliance 142. The CLI deployment process may include preparing a JSON configuration file with deployment information and running the deployment command to deploy virtualization manager appliance 142. As mentioned, virtualization manager appliance 142 may be configured to run virtualization manager 140 for host cluster 101.

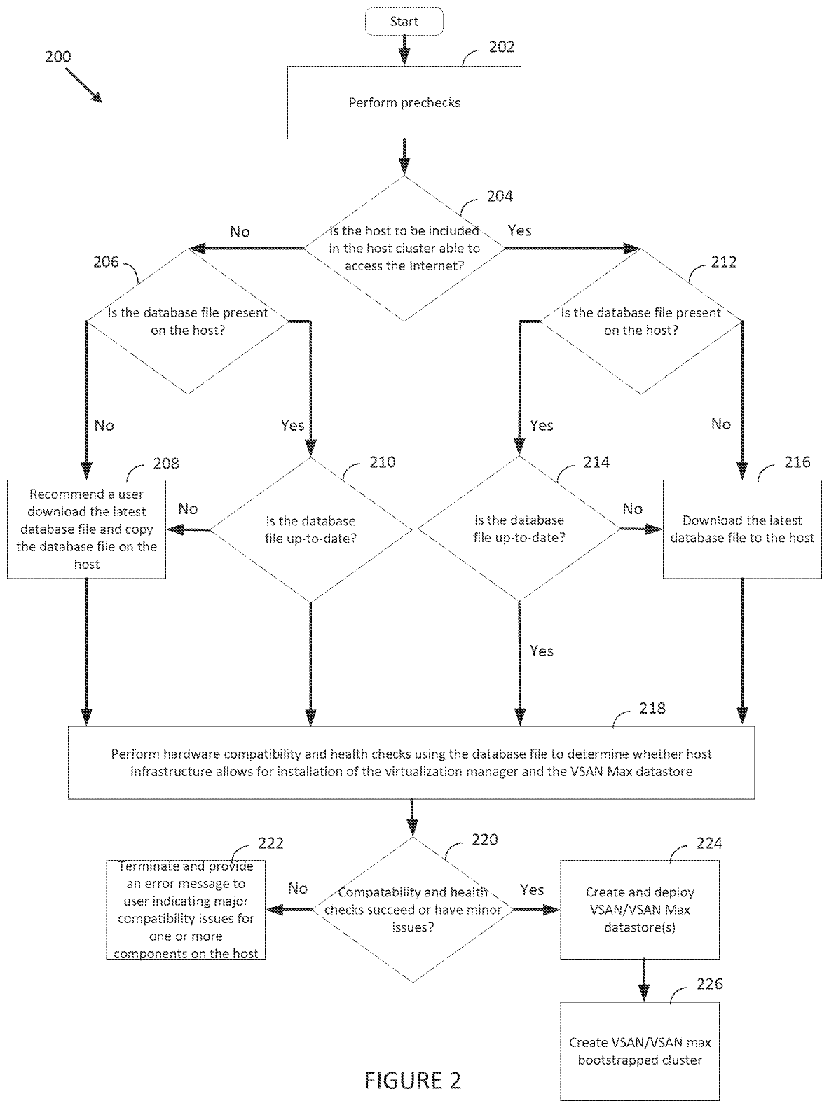

FIG. 2 illustrates an example workflow 200 for performing hardware compatibility and health checks prior to VSAN creation and deployment, according to an example embodiment of the present disclosure. Workflow 200 may be performed by CLI installer 150 and agent(s) 152 on host(s) 102 in host cluster 101 illustrated in FIG. 1. Workflow 200 may be performed to create a single host, VSAN (e.g., VSAN 122 and/or VSAN Max 124) bootstraped cluster 101.

Workflow 200 may be triggered by CLI installer 150 receiving a template regarding virtualization manager 140 and VSAN 122/VSAN Max 124 deployment. In particular, CLI installer 150 may provide a template to a user to modify. In certain aspects, a user may indicate, in the template, a desired state for the virtualization manager 140 to be deployed. Further, in certain aspects, a user may specify, in the template, desired state parameters for a VSAN 122/VSAN Max 124 to be deployed. The desired state parameters may specify disks that are available for VSAN creation and specifically which of these disks may be used to create the VSAN storage pool. A user may also indicate, via the template, whether VSAN Max 124 is to be enabled. For example, a user may set a VSAN Max flag in the template to “true” to signify that VSAN Max should be enabled. An example template is provided below:

```
″VCSA_cluster” : {
  ″_comments” : [
      ″Optional selection. You must provide this option if you want to
      create the vSAN
    bootstrap cluster”
  ] ,
  “datacenter” : “Datacenter”,
  “cluster” : “vsan_cluster”,
  “disks_for_vsan” : {
      ″cache_disk” : [
            ″0000000000766d686261303a323a30”
        ] ,
        ″capacity_disk” : [
            ″0000000000766d686261303a313a30”
            ″0000000000766d686261303a333a30”
          ] ,
  } ,
  “enable_vlcm” : true ,
  “enable_vsan_max” : true ,
  “storage_pool” : [
            ″0000000000766d686261303a323a30”
            ″0000000000766d686261303a313a30”
          ] ,
  ″vsan_hcl_database_path” : “/dbc/sc-dbc2146/username/
  scdbc_main_1/bora/install/vcsa-
    installer/vcsaCliInstaller”
```

As shown, three disks (e.g., one cache disk and two capacity disks) may be present on a host 102 to be included in host cluster 101. A user may specify that the cache disk (e.g., 0000000000766d686261303a323a30) and one of the capacity disks (e.g., 0000000000766d686261303a313a30) are to be used to create the VSAN storage pool. Further, because the user has set “enable_vsan_max” to “true”, CLI installer 150 may know to enable VSAN MAX 124 for host cluster 101.

In this template, a file path for a database file, such as database file 154, may also be provided (e.g., provided as “vsan_hcl_database_path” in the template above). In certain aspects, as described in more detail below, CLI installer 150 may use this file path provided in the template to fetch database file 154 and upload database file 154 to host 102 to be included in host cluster 101.

As shown in FIG. 2, after receiving the template at CLI installer 150, workflow 200 begins at operation 202 by CLI installer 150 performing prechecks at operation 202. Prechecks may include determining whether input parameters in the template are valid, and whether installation can proceed until completion.

At operation 204, CLI installer 150 checks whether host 102 to be included in host cluster 101 is able to access the internet. A host 102 which is not able to access the internet may be considered an air gapped host 102. In this example, at operation 204, CLI installer 150 checks whether the single host 102 is able to access the internet.

In certain aspects, host 102 may be an air gapped host 102. Accordingly, at operation 204, CLI installer 150 determines that host 102 is not able to access the internet. Thus, at operation 206, CLI installer 150 determines whether database file 154 is present on host 102 (e.g., in storage 120 or memory 114 on host 102). Where it is determined at operation 206 that database file 154 is not present on host 102, CLI installer 150 may provide an error message to a user at operation 208. The error message may indicate that database file 154 is not present on host 102 and further recommend a user download the latest database file 154 and copy database file 154 on host 102. In this case, because host 102 is not connected to the internet, a user may have to manually copy database file 154 to host 102. In response to receiving the recommendation, a user may copy database file 154 to host 102.

Alternatively, where it is determined at operation 206 that database file 154 is present on host 102, CLI installer 150 determines whether database file 154 on host 102 is up-to-date. In certain aspects, a database file 154 may be determined to be up-to-date where database file 154 is less than six months old based on the current system time.

In some cases, as shown in FIG. 2, where database file 154 is determined not to be up-to-date at operation 210, at operation 208, CLI installer 150 may provide an error message to a user at operation 208. The error message may indicate that database file 154 on host 102 is not up-to-date and further recommend a user download the latest database file 154 and copy database file 154 on host 102.

In some other cases, not shown in FIG. 2, instead of recommending a user download a current database file 154 when database file 154 on host 102 is determined to be outdated, a warning message may be provided to a user. The warning message may warn that hardware compatibility and/or health checks are to be performed with the outdated database file 154.

Returning to operation 204, in certain aspects, host 102 may be an internet-connected host 102. Accordingly, at operation 204, CLI installer 150 determines that host 102 is able to access the internet. Thus, at operation 210, CLI installer 150 determines whether database file 154 is present on host 102 (e.g., in storage 120 or memory 114 on host 102). Where it is determined at operation 212 that database file 154 is not present on host 102, CLI installer 150 may use the database file path provided in the template received by CLI installer 150 (e.g., prior to workflow 200) to fetch and download database file 154 to host 102. In this case, because host 102 is connected to the internet, CLI installer 150 may download database file 154 to host 102, as opposed to requiring a user to manually copy database file 154 to host 102.

Alternatively, where it is determined at operation 212 that database file 154 is present on host 102, CLI installer 150 determines whether database file 154 on host 102 is up-to-date. In cases where CLI installer 150 determines database file 154 on host 102 is outdated at operation 214, a newer, available version of database file 154 may be downloaded from the Internet at operation 216. Database file 154 may be constantly updated; thus, CLI installer 150 may need to download a new version of database file 154 to ensure a local copy of database file 154 stored on host 102 is kept up-to-date. In cases where CLI installer 150 determines database file 154 on host 102 is up-to-date at operation 214, database file 154 may be used to perform hardware compatibility and/or health checks.

Database file 154 on host 102 (e.g., database file 154 previously present on host 102, database file recently downloaded to host 102, or database file 154 recently copied to host 102 by a user) may contain a subset of information of a larger database file. In particular, the larger database file may contain certified hardware components and their compatibility matrix for multiple supported host version releases, while database file 154 on host 102 may contain certified hardware components for a version release of host 102. A host version release may refer to the version of VSAN software or hypervisor being installed or installed on the host 102. In other words, a larger database file may be downloaded to a jumphost where CLI installer 150 is running and trimmed to retain data related to the particular version of host 102 (and remove other data). The trimmed database file 154 (e.g., including the retained data) may be downloaded to host 102. For example, database file may contain certified hardware components and their particulars for a host version 7.0, a host version 6.7, a host version 6.5, and a host version 6.0. Where host 102 is a version 7.0 host, only information specific to a host 7.0 release in database file 154 may be kept and downloaded to host 102.

In certain aspects, the size of database file 154 may be less than 20 kb. Database file 154 may be stored on host 102, as opposed to the larger database file, to account for memory and/or storage limitations of host 102.

At operation 218, CLI installer 150 requests agent 152 on host 102 to perform hardware compatibility checks using database file 154, as well as health checks. In response to the request, agent 152 performs such hardware compatibility checks and health checks. For example, in certain aspects, agent 152 checks system information via an operating system (OS) of host 102 to determine information (e.g., models, versions, etc.) about hardware installed on host 102 and/or resource (CPU, memory, etc.) availability and usage on host 102. Agent 152 may use this information to determine whether hardware installed on host 102 and/or resources available on hosts 102 are compatible and/or allow for VSAN 122 and/or VSAN Max 124 deployment.

Various hardware compatibility checks and/or health checks performed by agent 152 may be considered. Agent 152 may determine whether each check has passed without any issues, passed with a minor issue, or failed due to a major compatibility issue. A minor issue may be referred to herein as a soft stop, while a major compatibility issue may be referred to herein as a hard stop. A soft stop may result where minimum requirements are met, but recommended requirements are not. A hard stop may result where minimum and recommended requirements are not met. A soft stop may not prevent the deployment of VSAN 122 and/or VSAN Max 124, but, in some cases, may result in a warning message presented to a user. A hard stop may prevent the deployment of VSAN 122 and/or VSAN Max 124, and thus result in a termination of workflow 200. In certain aspects, agent 152 provides a report indicating one or more passed checks, soft stops, and hard stops to CLI installer 150.

In certain aspects, at operation 218, agent 152 may check whether a disk to be provided by host 102 for the creation of VSAN 122 and/or VSAN Max 124 is present on host 102. As mentioned, in certain aspects, a user may specify, in a template (as described above), disks that are to be used to create a VSAN 122 and/or VSAN Max 124 storage pool. Agent 152 may verify that disks in this list are present on their corresponding host 102.

In certain aspects, at operation 218, agent 152 may check whether a disk provided by host 102 is certified. More specifically, agent 152 may confirm whether the disk complies with a desired storage mode for VSAN 122 and/or VSAN Max 124 (e.g., where a flag in the template indicates that VSAN Max is to be enabled). A disk that does not comply with the desired storage mode for VSAN 122 and/or VSAN Max 124 may be considered a hard stop. In some cases, the disk may be a nonvolatile memory express (NVMe) disk.

In certain aspects, at operation 218, agent 152 may check whether physical memory available on host 102 is less than a minimum VSAN 122/VSAN Max 124 memory requirement for VSAN deployment. Physical memory available on host 102 less than the minimum memory requirement may be considered a hard stop.

In certain aspects, at operation 218, agent 152 may check whether a CPU on host 102 is compatible with the VSAN 122/VSAN Max 124 configuration. If CPU is determined not to be compatible with the VSAN 122/VSAN Max 124 configuration, this may be considered a hard stop.

In certain aspects, at operation 218, agent 152 may check whether an installed input/output (I/O) controller driver on host 102 is supported for a corresponding controller in database file 154. If the installed driver is determined not to be supported, this may be considered a hard stop.

In certain aspects, at operation 218, agent 152 may check link speeds for NICs 116 on host 102. In certain aspects, NIC link speed requirements (e.g., pre-determined NIC link speed requirements) may necessitate that NIC link speeds are at least 25 Gbps. NIC requirements may assume that the packet loss is not more than 0.0001% in hyper-converged environments. NIC link speed requirements may be set to avoid poor VSAN performance after deployment. NIC link speeds on host 102 less than the minimum NIC link speed requirement may be considered a soft stop.

In certain aspects, at operation 218, agent 152 may check the age of database file 154 on host 102. A database file 154 on host 102 which is older than 90 days but less than 181 days may be considered a soft stop. A database file 154 on host 102 which is older than 180 days may be considered a hard stop.

In certain aspects, at operation 218, agent 152 may check whether database file 154, prior to being trimmed and downloaded to host 102, contains certified hardware components for a version release of host 102. A database file 154 on host 102 which does not contain certified hardware components for a version release of host 102 may be considered a soft stop.

In certain aspects, at operation 218, agent 152 may check the compliance of one or more components on host 102 against database file 154. A component may be deemed compatible where a model, driver, and/or firmware version of the component is found in database file 154.

As mentioned, in certain aspects, agent 152 provides, to CLI installer 150, a report indicating one or more checks performed on host 102 and their corresponding result: passed, soft stop, or hard stop. At operation 220, CLI installer 150 determines whether the hardware compatibility checks and health checks performed on host 102 have succeeded, or present minor issues. CLI installer 150 determines, at operation 220, that the hardware compatibility and health checks performed on host 102 have succeeded, or present minor issues, where results contained in the report from agent 152 include only passed and soft stop results. Alternatively, CLI installer 150 determines, at operation 220, that the hardware compatibility and health checks performed on host 102 have not succeeded where results contained in the report from agent 152 include at least one hard stop result for at least one check performed on host 102.

In cases where the hardware compatibility and health checks do not succeed, at operation 222, CLI installer 150 terminates workflow 200 (e.g., terminates procedure to deploy VSAN 122/VSAN Max 124, install virtual manager appliance 142, and run virtual manager 140). Further, CLI installer 150 may provide an error message to a user indicating major compatibility issues for one or more components on the host. In some cases, a user may use the error message to determine what steps to remedy this situation such that the VSAN bootstrapped cluster may be created.

In cases where the hardware compatibility and health checks do succeed, at operation 224, CLI installer 150 creates and deploys VSAN 122 and/or VSAN Max 124 (e.g., where a flag in the template indicates that VSAN Max is to be enabled). In particular, disks listed for the VSAN storage pool listed in the template received by CLI installer 150 may be collected to create the datastore. VSAN 122 and/or VSAN Max 124 may be enabled on the created datastore for host cluster 101 (e.g., including host 102).

At operation 226, workflow 200 proceeds to create VSAN/VSAN Max bootstrapped cluster 101. In particular, VSAN 122 and/or VSAN Max 124 may be deployed for host cluster 101.

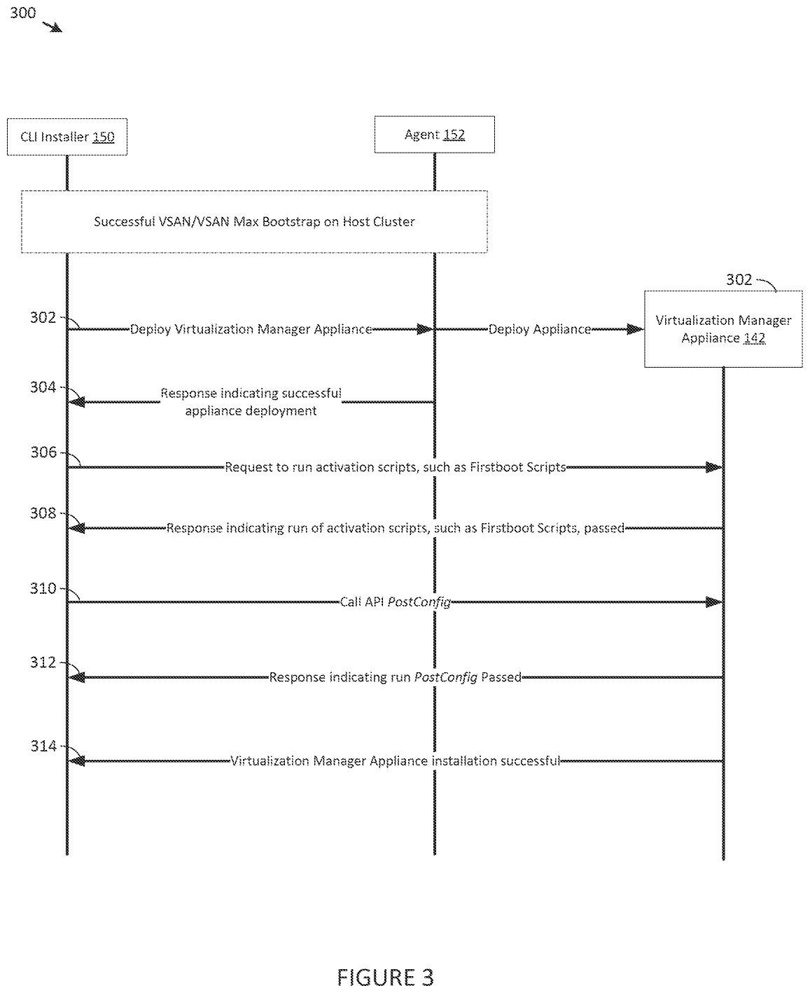

As part of creating the VSAN/VSAN Max bootstrapped cluster 101, a virtualization manager 140 may be installed and deployed. FIG. 3 is a call flow diagram illustrating example operations 300 for virtualization manager 140 installation, according to an example embodiment of the present disclosure. Operations 300 may be performed by CLI installer 150 and agent(s) 152 on host(s) 102 in host cluster 101 illustrated in FIG. 1, and further virtualization manager appliance 142, illustrated in FIG. 1, after deployment.

As shown in FIG. 3, operations 300 begins at operation 302 (after successful VSAN 122/VSAN Max 124 bootstrap on host cluster 101) by CLI installer 150 deploying a virtualization manager appliance, such as virtualization manager appliance 142 illustrated in FIG. 1. CLI installer 150 may invoke agent 152 to deploy virtualization manager appliance 142. At operation 304, agent 152 may indicate to CLI installer 150 that virtualization manager appliance 142 has been successfully deployed. In certain aspects, an OVA file is deployed as virtualization manager appliance 142.

At operation 306, CLI installer 150 requests virtualization manager appliance 142 to run activation scripts, such as Firstboot scripts. Where Firstboot scripts are successful, the Firstboot scripts call the virtualization manager 140 profile application programming interface (API) to apply a desired state. Further, on Firstboot scripts success, at operation 308, virtualization manager appliance 142 indicates to CLI installer 150 that running the Firstboot scripts has been successful.

At operation 310, CLI installer 150 calls API PostConfig. In other words, CLI installer 150 calls the virtualization manager 140 profile API to check whether the desired state has been properly applied. In response, at operation 312, virtualization manager appliance 142 responds indicating PostConfig has been successful, and more specifically, indicating that the desired state has been properly applied. Subsequently, at operation 314, virtualization manager appliance 142 indicates that virtualization manager appliance 142 installation has been successful. Thus, virtualization manager appliance 142 may now run virtualization manager 140 for host cluster 101.

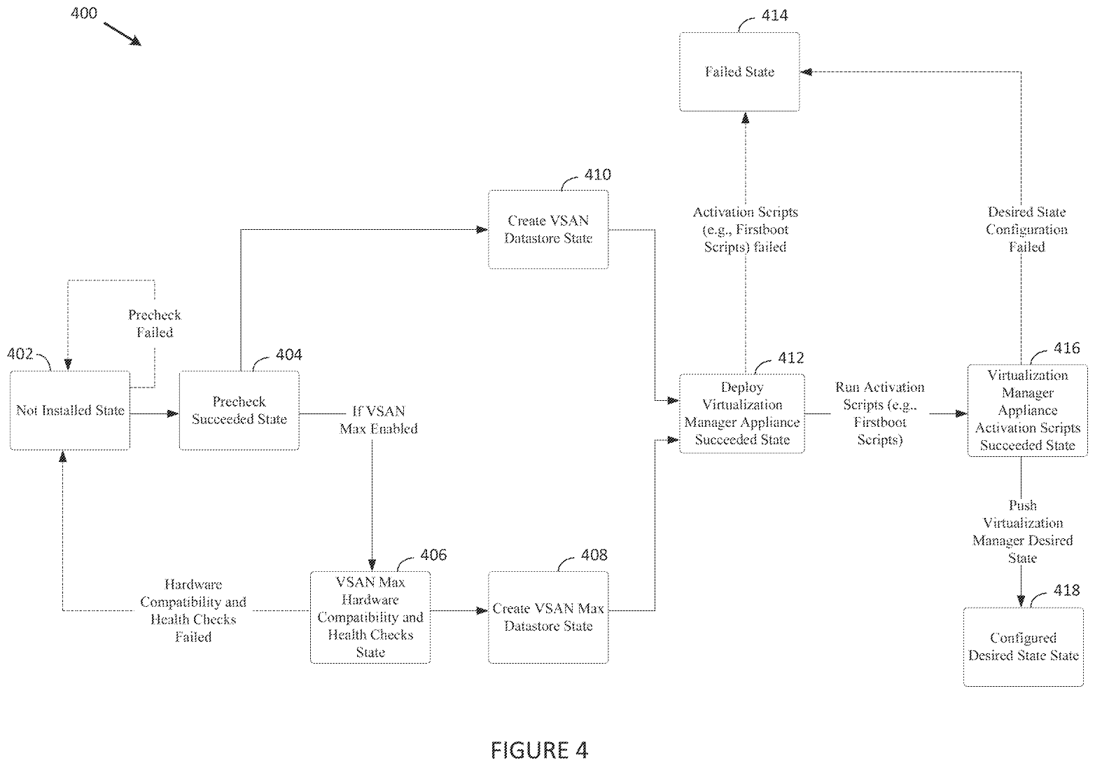

FIG. 4 is an example state diagram 400 illustrating different states during a VSAN bootstrap workflow, as described herein. A state diagram is a type of diagram used to describe the behavior of a system. In particular, state diagram 400 may be a behavioral model consisting of states, state transitions, and actions taken at each state defined for the system during a VSAN bootstrap workflow. The state represents the discrete, continuous segment of time where behavior of the system is stable. The system may stay in a state defined in diagram 400 until the state is stimulated to change by actions taken while the system is in that state.

State diagram 400 may be described with respect to operations illustrated in FIG. 2 and FIG. 3. As shown in FIG. 4, the initial state of the system is a “Not Installed State” 402. At the “Not Installed” 402, VSAN 122 and/or VSAN Max 124 may not be deployed and virtualization manager appliance 142 may not be installed. At “Not Installed State” 402, operation 202 (e.g., illustrated in FIG. 2) is carried out to perform existing prechecks. In some cases, the prechecks may fail, and thus the system may remain in a “Not Installed State”. In some cases, the prechecks may succeed, and the system may proceed to a “Precheck Succeeded State” 404. In the “Precheck Succeeded State” 404, CLI installer 150 may check the template to determine whether a flag has been set indicating VSAN Max 124 is to be enabled. If VSAN Max 124 is enabled (e.g., a value is set to “true” in the template for VSAN Max 124 enablement), the system transitions to a “VSAN Max Hardware Compatibility and Health Checks State” 406. Operation 218 illustrated in FIG. 2 may be performed while in the “VSAN Max Hardware Compatibility and Health Checks State” 406. In other words, while in the “VSAN Max Hardware Compatibility and Health Checks State” 406, CLI installer 150 requests agent(s) 152 on host(s) 102 (e.g., to be included in a host cluster 101) to perform hardware compatibility and/or health checks using database file(s) 154 stored on host(s) 102.

In some cases, the hardware compatibility and/or health checks performed by agent(s) 152 may not succeed (e.g., result in hard stops). In such cases, the system may return to the “Not Installed State” 402. In some other cases, the hardware compatibility and/or health checks performed by agent(s) 152 may succeed (e.g., result in no hard stops). In such cases, the system may transition to a “Create VSAN Max Datastore State” 408. In this state, operation 224 illustrated in FIG. 2 may be performed to collect disks listed for the VSAN Max 124 storage pool listed in the template. Further, in this state, VSAN Max 124 and a virtualization manager appliance 142 may be deployed. After the creation and deployment of VSAN Max 124 and virtualization manager appliance 142, the system may transition to a “Deploy Virtual Manager Appliance Succeeded State” 412.

Returning back to “Precheck Succeeded State 404”, in some cases, CLI installer 150 may determine that VSAN Max 124 has not been enabled (e.g., a value is set to “false” in the template for VSAN Max 124 enablement). Accordingly, the system transitions to a “Create VSAN Datastore State” 410. In this state, operation 224 illustrated in FIG. 2 may be performed to collect disks listed for the VSAN 122 storage pool listed in the template. Further, in this state, VSAN 122 and a virtualization manager appliance 142 may be deployed and. After the creation and deployment of VSAN Max 122 124 and virtualization manager appliance 142, the system may transition to the “Deploy Virtual Manager Appliance Succeeded State” 412.

Though FIG. 4 illustrates hardware compatibility and health checks only being performed where VSAN Max 124 is enabled (e.g., in the template), in certain aspects, such hardware compatibility and/or health checks may be performed prior to creation of VSAN 122, as well.

At the “Deploy Virtual Manager Appliance Succeeded State” 412, operation 306 illustrated in FIG. 3 may be carried out to run activation scripts, such as Firstboot scripts. In some cases, running the activation scripts may fail. In such cases, the system may transition to “Failed State” 414. In some other cases, running the activation scripts may be successful. In such cases, the system may transition to a “Virtualization Manager Appliance Activation Scripts Succeeded State” 416.

At the “Virtualization Manager Appliance Activation Scripts Succeeded State” 416, a desired state configuration may be pushed to virtualization manager appliance 142. In some cases, the desired state configuration may fail. Accordingly, the system may transition to the “Failed State” 414. In some other cases, the desired state configuration may be applied to virtualization manager appliance 142, and the system may transition to a “Configured Desired State State” 418. At this point, virtualization manager appliance 142 may run virtualization manager 140 for a VSAN bootstrapped cluster 101 that has been created.

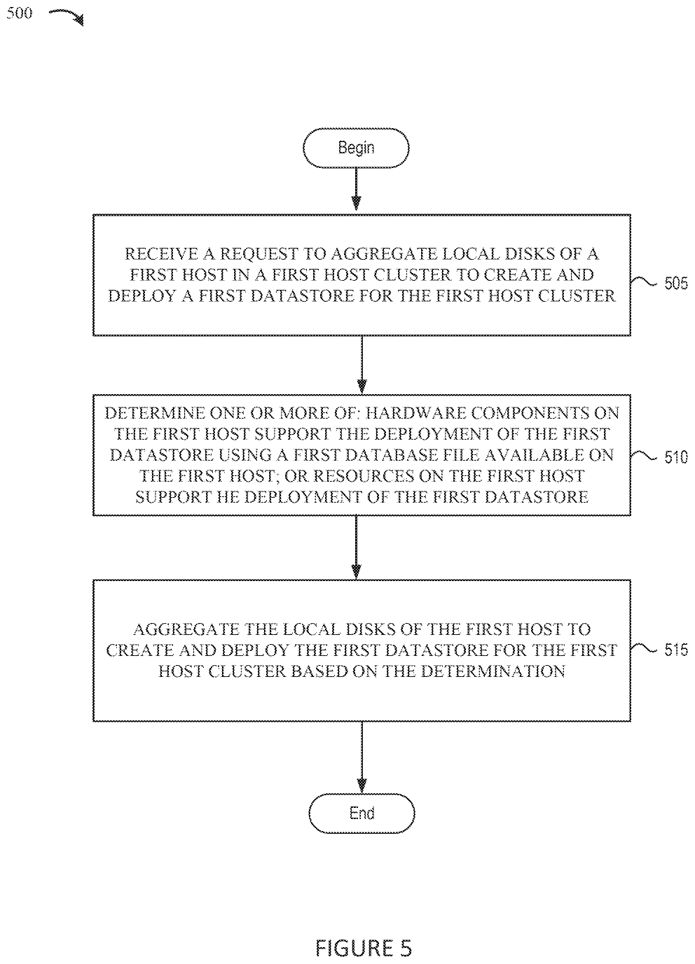

FIG. 5 is a flow diagram illustrating example operations 500 for performing at least one of hardware component compatibility checks or resource checks for datastore deployment. In certain aspects, operations 500 may be performed by CLI installer 150, agent(s) 152, and virtualization manager appliance 142 illustrated in FIG. 1.

Operations 500 begin, at operation 505, by CLI installer 150 receiving a request to aggregate local disks of a first host in a first host cluster to create and deploy a first datastore for the first host cluster.

At operation 505, agent(s) 152 determine one or more of: hardware components on the first host support the deployment of the first datastore using a first database file available on the first host or resources on the first host support the deployment of the first datastore. In certain aspects, determining the hardware components on the first host support the deployment of the first datastore comprises determining at least one of a model, a version, or a firmware of the hardware components on the first host matches at least one of a model, a version, or a firmware of a corresponding hardware component in the first database file on the first host. The first database file may include certified hardware components for the deployment of the first datastore, wherein at least one of a model, a version, or a firmware is listed for each of the certified hardware components. In certain aspects, determining the resources on the first host support the deployment of the first datastore comprises determining at least one of: local disks on the first host are present on the first host; local disks on the first host comply with a desired storage mode of the first datastore; installed drivers on the first host are supported for corresponding controllers listed in the first database file available on the first host; link speeds of NICs on the first host satisfy at least a minimum NIC link speed; available CPU on the first host is compatible with a configuration for the first datastore; or available memory on the first host satisfies at least a minimum memory requirement for the first datastore.

In certain aspects, determining one or more of the hardware components or resources on the first host support the deployment of the first datastore comprises determining at least one issue exists with respect to at least one of the hardware components or resources on the first host.

At operation 510, the local disks of the first host are aggregated to create and deploy the first datastore for the first host cluster based on the determination.

In certain aspects, operations 500 further include receiving a request to aggregate local disks of a second host in a second host cluster to create and deploy a second datastore for the second host cluster; determining at least one of one or more hardware components on the second host do not support the deployment of the second datastore using a second database file available on the second host or one or more resources on the second host do not support the deployment of the second datastore; and terminating the creation and the deployment of the second datastore for the second host cluster.

In certain aspects, operations 500 further include downloading the first database file to the first host when a current database file on the first host is outdated or a database file is not available on the first host.

In certain aspects, operations 500 further include recommending a user download and copy the first database file to the first host when a current database file on the first host is outdated or a database file is not available on the first host.

In certain aspects, operations 500 further include installing a virtual manager appliance to run a virtual manager for the first host cluster, wherein the virtual manager provides a single point of control to the first host within the first host cluster

The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), NVMe storage, Persistent Memory storage, a CD (Compact Discs), CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

In addition, while described virtualization methods have generally assumed that virtual machines present interfaces consistent with a particular hardware system, the methods described may be used in conjunction with virtualizations that do not correspond directly to any particular hardware system. Virtualization systems in accordance with the various embodiments, implemented as hosted embodiments, non-hosted embodiments, or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and datastores are somewhat arbitrary, and particular operations are illustrated in the context of specific illustrative configurations. Other allocations of functionality are envisioned and may fall within the scope of one or more embodiments. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s). In the claims, elements and/or steps do not imply any particular order of operation, unless explicitly stated in the claims.

What is claimed is:

1. A method of performing at least one of hardware component compatibility checks or resource checks for datastore deployment, the method comprising:
receiving a request to aggregate local disks of a first host in a first host cluster to create and deploy a first datastore for the first host cluster;
determining one or more of:
hardware components on the first host support the deployment of the first datastore using a first database file available on the first host; or
resources on the first host support the deployment of the first datastore; and
aggregating the local disks of the first host to create and deploy the first datastore for the first host cluster based on the determination.

2. The method of claim 1, wherein the determining the hardware components on the first host support the deployment of the first datastore comprises determining at least one of a model, a version, or a firmware of the hardware components on the first host matches at least one of a model, a version, or a firmware of a corresponding hardware component in the first database file on the first host.

3. The method of claim 1, wherein the determining the resources on the first host support the deployment of the first datastore comprises determining at least one of:
local disks on the first host are present on the first host;
local disks on the first host comply with a desired storage mode of the first datastore;
installed drivers on the first host are supported for corresponding controllers listed in the first database file available on the first host;
link speeds of network interface cards (NICs) on the first host satisfy at least a minimum NIC link speed;
available central processing unit (CPU) on the first host is compatible with a configuration for the first datastore; or
available memory on the first host satisfies at least a minimum memory requirement for the first datastore.

4. The method of claim 1, wherein the first database file comprises certified hardware components for the deployment of the first datastore, wherein at least one of a model, a version, or a firmware is listed for each of the certified hardware components.

5. The method of claim 1, wherein the determining one or more of the hardware components or resources on the first host support the deployment of the first datastore comprises determining at least one issue exists with respect to at least one of the hardware components or resources on the first host.

6. The method of claim 1, further comprising:
receiving a request to aggregate local disks of a second host in a second host cluster to create and deploy a second datastore for the second host cluster;
determining at least one of one or more hardware components on the second host do not support the deployment of the second datastore using a second database file available on the second host or one or more resources on the second host do not support the deployment of the second datastore; and
terminating the creation and the deployment of the second datastore for the second host cluster.

7. The method of claim 1, further comprising:
downloading the first database file to the first host when a current database file on the first host is outdated or a database file is not available on the first host.

8. The method of claim 1, further comprising:
recommending a user download and copy the first database file to the first host when a current database file on the first host is outdated or a database file is not available on the first host.

9. The method of claim 1, further comprising:
installing a virtual manager appliance to run a virtual manager for the first host cluster, wherein the virtual manager provides a single point of control to the first host within the first host cluster.

10. A system comprising:
one or more processors; and
at least one memory, the one or more processors and the at least one memory configured to cause the system to:
receive a request to aggregate local disks of a first host in a first host cluster to create and deploy a first datastore for the first host cluster;
determine one or more of:
hardware components on the first host support the deployment of the first datastore using a first database file available on the first host; or
resources on the first host support the deployment of the first datastore; and
aggregate the local disks of the first host to create and deploy the first datastore for the first host cluster based on the determination.

11. The system of claim 10, wherein the one or more processors and the at least one memory are configured to cause the system to determine the hardware components on the first host support the deployment of the first datastore by determining at least one of a model, a version, or a firmware of the hardware components on the first host matches at least one of a model, a version, or a firmware of a corresponding hardware component in the first database file on the first host.

12. The system of claim 10, wherein the one or more processors and the at least one memory are configured to cause the system to determine the resources on the first host support the deployment of the first datastore by determining at least one of:
local disks on the first host are present on the first host;
local disks on the first host comply with a desired storage mode of the first datastore;
installed drivers on the first host are supported for corresponding controllers listed in the first database file available on the first host;
link speeds of network interface cards (NICs) on the first host satisfy at least a minimum NIC link speed;
available central processing unit (CPU) on the first host is compatible with a configuration for the first datastore; or
available memory on the first host satisfies at least a minimum memory requirement for the first datastore.

13. The system of claim 10, wherein the first database file comprises certified hardware components for the deployment of the first datastore, wherein at least one of a model, a version, or a firmware is listed for each of the certified hardware components.

14. The system of claim 10, wherein the one or more processors and the at least one memory are configured to cause the system to determine one or more of the hardware components or resources on the first host support the deployment of the first datastore by determining at least one issue exists with respect to at least one of the hardware components or resources on the first host.

15. The system of claim 10, wherein the one or more processors and the at least one memory are further configured to cause the system to:
receive a request to aggregate local disks of a second host in a second host cluster to create and deploy a second datastore for the second host cluster;
determine at least one of one or more hardware components on the second host do not support the deployment of the second datastore using a second database file available on the second host or one or more resources on the second host do not support the deployment of the second datastore; and
terminate the creation and the deployment of the second datastore for the second host cluster.

16. The system of claim 10, wherein the one or more processors and the at least one memory are further configured to cause the system to:
download the first database file to the first host when a current database file on the first host is outdated or a database file is not available on the first host.

17. The system of claim 10, wherein the one or more processors and the at least one memory are further configured to cause the system to:
recommend a user download and copy the first database file to the first host when a current database file on the first host is outdated or a database file is not available on the first host.

18. The system of claim 10, wherein the one or more processors and the at least one memory are further configured to cause the system to:
install a virtual manager appliance to run a virtual manager for the first host cluster, wherein the virtual manager provides a single point of control to the first host within the first host cluster.

19. A non-transitory computer-readable medium comprising instructions that, when executed by one or more processors of a computing system, cause the computing system to perform operations for at least one of hardware component compatibility checks or resource checks for datastore deployment, the operations comprising:
receiving a request to aggregate local disks of a first host in a first host cluster to create and deploy a first datastore for the first host cluster;
determining one or more of:
hardware components on the first host support the deployment of the first datastore using a first database file available on the first host; or
resources on the first host support the deployment of the first datastore; and
aggregating the local disks of the first host to create and deploy the first datastore for the first host cluster based on the determination.

20. The non-transitory computer-readable medium of claim 19, wherein the determining the hardware components on the first host support the deployment of the first datastore comprises determining at least one of a model, a version, or a firmware of the hardware components on the first host matches at least one of a model, a version, or a firmware of a corresponding hardware component in the first database file on the first host.
